(19) United States
(12) Patent Application Publication
(10) Pub. No.: US 2007/0183928 A1
(43) Pub. Date: Aug. 9, 2007

(54) VARIABLE FLOW RATE SYSTEM FOR COLUMN CHROMATOGRAPHY

(75) Inventors: David W. Neyer, Castro Valley, CA (US); David J. Rakestraw, Livermore, CA (US); Christopher G. Bailey, Livermore, CA (US); Karen Hahnenberger, Livermore, CA (US)

Correspondence Address: SHELDON MAK ROSE & ANDERSON PC, 100 East Corson Street, Third Floor, PASADENA, CA, 91103-3842, US

(73) Assignee: EKSIGENT TECHNOLOGIES, LLC, Dublin, CA (US)

(21) Appl. No.: 11/530,389

(22) Filed: Sep. 8, 2006

Related U.S. Application Data
(60) Provisional application No. 60/716,038, filed on Sep. 9, 2005.

(51) Int. Cl. G01N 30/02; C02F 1/28; G01N 30/00; B01D 15/08

(52) U.S. Cl. 422/70; 73/61.52; 210/656

(57) ABSTRACT

A chromatography system having continuously variable sources of fluid pressure and a controller to control the flow rates of one or more carrier fluids during an HPLC separation, the controller being responsive to the rate of analyte elution from a sample.

### CROSS-REFERENCE TO RELATED APPLICATIONS

This application claims the benefit of priority from U.S. Provisional Patent Application No. 60/716,038, filed on Sep. 8, 2005 and titled “Variable Flow Rate System for Column Chromatography.” This application is incorporated herein in its entirety by reference

### BACKGROUND

High Performance Liquid Chromatography (HPLC) is a method for separating the components of a sample mixture, thereby allowing the individual components of the mixture to be characterized. The components to be separated are distributed between two phases, a stationary phase (generally contained in a column) and a mobile phase which migrates through the stationary phase. The differential rates of migration of components through the stationary phase produce a separation of the components.

Parameters affecting the speed and quality of an HPLC separation include the flow rate of the mobile phase used in the separation and the chemical composition of the mobile phase. These parameters can be changed during a separation in order to slow the elution of components from an HPLC column and thereby increase the time available to analyze these sample components, a technique known as “peak parking.” Optimizing HPLC separations, such as through the use of peak parking, however, adds to the time and expense of performing HPLC separations. There remains a need, therefore, for ways to increase the speed and/or efficiency of HPLC separations.

### SUMMARY

The present system for analyzing a sample comprises, in one embodiment, a first source of continuously variable fluid pressure for applying pressure to a first carrier fluid, such as a pneumatic pump, electrokinetic pump, or electrokinetic flow controller; a first chromatography column having an inlet end and an outlet end, the inlet end of the chromatography column being in fluid communication with the source of continuously variable fluid pressure; a first detector in fluid communication with the outlet end of the chromatography column; and one or more controllers in electrical communication with the first source of continuously variable fluid pressure and with the first detector. The controllers comprise circuitry for receiving sample data from the first detector, determining a desired carrier fluid flow rate for the first carrier fluid based on the sample data, and adjusting the pressure applied by the first source of continuously variable fluid pressure to achieve the desired flow rate for the first carrier fluid. The first chromatography column preferably has an internal diameter of 2 millimeters or less. In addition, the present system preferably includes a flowmeter in fluid communication with the first source of continuously variable fluid pressure and with the first chromatography column, and in electrical communication with the controllers, in which case the controllers comprise circuitry for receiving flow rate data from the flowmeter.

The present system preferably also comprises a second source of continuously variable fluid pressure for applying pressure to a second carrier fluid, the second source of continuously variable fluid pressure being in electrical communication with the one or more controllers. In this embodiment, the one or more controllers comprise circuitry for determining a desired flow rate for the second carrier fluid based on the sample data, and can produce a desired flow rate for the first carrier fluid and the second carrier fluid which changes over time, thereby providing a carrier fluid gradient. The system preferably has a ratio between its delay volume and its column volume of less than 0.5 in order to ensure a rapid change in the carrier fluid gradient.

In another embodiment, the present system comprises a first source of continuously variable fluid pressure for applying pressure to a first carrier fluid, a first flowmeter in fluid communication with the first source of continuously variable fluid pressure, and one or more controllers in electrical communication with the first source of continuously variable fluid pressure and with the first flowmeter. The controllers comprise circuitry for receiving sample data from a first detector; utilizing the sample data to determine an optimized flow rate for the first carrier fluid for analyzing the sample in less time or in a manner which allows more sample data or sample data of a desired quality to be obtained by the detector than under the conditions which are not optimized; receiving flow rate data from the first flowmeter; comparing the flow rate data to the optimized carrier fluid flow rate; and adjusting the pressure applied by the first source of continuously variable fluid pressure to achieve the optimized flow rate for the first carrier fluid. The sample data can comprise the number of analytes entering the detector during a predetermined period of time, and the optimized flow rate of the first carrier fluid preferably results in the detector receiving analytes at a rate which is less than a predetermined maximum rate for the detector.

In a preferred embodiment, the system further comprises a second source of continuously variable fluid pressure for applying pressure to a second carrier fluid, the second source of continuously variable fluid pressure being in electrical communication with the one or more controllers, as well as a second flowmeter in fluid communication with the second source of continuously variable fluid pressure and in electrical communication with the one or more controllers. The controllers in this case further comprise circuitry for determining an optimized flow rate for the second carrier fluid based on the sample data and for adjusting the pressure applied by the second source of continuously variable fluid pressure to achieve the optimized flow rate for the second carrier fluid. The optimized flow rate for the first carrier fluid and the second carrier fluid can change over time, thereby providing a carrier fluid gradient. Such a system also preferably has a ratio between its delay volume and its column volume of less than 0.5.

In another aspect, a method for performing a chromatography procedure is provided, the method comprising the steps of applying pressure from a first source of continuously variable fluid pressure to a first carrier fluid in order to flow the first carrier fluid at a first flow rate of less than about 100 μL/min; contacting the sample with the first carrier fluid; flowing the sample and the carrier fluid through a chromatography column; analyzing components of the sample with a detector, thereby generating sample data; processing the sample data with one or more controllers to determine whether the rate at which analytes are being detected by the detector is greater than a predetermined maximum rate or is less than a predetermined rate at which the detector can analyze analytes; determining a second flow rate for the first carrier fluid with the one or more controllers when the rate at which analytes are being detected by the detector is greater than the predetermined maximum rate or is less than the predetermined rate at which the detector can analyze analytes, the second flow rate resulting in a flow of analytes into the detector which is less than the predetermined maximum rate or which is greater than the predetermined rate at which the detector can analyze analytes; and changing the pressure applied by the first source of continuously variable fluid pressure and thereby changing the flow rate of the first carrier fluid from the first flow rate to the second flow rate for the first carrier fluid. Preferably, this method further comprises applying pressure from a second source of continuously variable fluid pressure to a second carrier fluid in order to flow the second carrier fluid at a second flow rate of less than about 100 μL/min; mixing the first carrier fluid and the second carrier fluid prior to contacting the sample with the first carrier fluid; determining a second flow rate for the second carrier fluid with the one or more controllers when the rate at which analytes are being detected by the detector is greater than the predetermined maximum rate or is less than the predetermined rate at which the detector can analyze analytes, the second flow rate resulting in a flow of analytes into the detector which is less than the predetermined maximum rate or which is greater than the predetermined rate at which the detector can analyze analytes; and changing the pressure applied by the second source of continuously variable fluid pressure and thereby changing the flow rate of the carrier fluid from the first flow rate to the second flow rate for the second carrier fluid. In this preferred embodiment, pressure can be applied by the first source of continuously variable fluid pressure and the second source of continuously variable fluid pressure to produce a first gradient, and adjusting the pressure applied by one or both of the first source of continuously variable fluid pressure and the second source of continuously variable fluid pressure produces a second gradient. Such a second gradient can comprise a time profile such as a linear, parabolic, exponential, or stepped profile. The system also preferably has a ratio between its delay volume and its column volume of less than 0.5.

### DRAWINGS

These and other features, aspects and advantages of the present invention will become better understood with regard to the following description, appended claims, and accompanying drawings where:

FIG. 1 is a diagram of the present chromatography system.

FIG. 2 is a diagram of another embodiment of the present chromatography system.

FIG. 3A is a chromatogram showing data recorded by a mass spectrometer during an HPLC separation of tryptic peptides from bovine serum albumin.

FIG. 3B is a chromatogram showing the average spectrum for ions eluting between 13.17 and 13.27 minutes in the separation of FIG. 3A.

FIG. 3C is a chromatogram showing the average spectrum for ions eluting between 13.9 and 14.0 minutes in the separation of FIG. 3A.

FIG. 4A is a chromatogram showing data recorded by a ultraviolet (UV) spectrometer during an HPLC separation of tryptic peptides from cytochrome C (shown by the solid line) in which the composition of the mobile phase changes in a linear fashion from 2% to 90% acetonitrile (the change in the mobile phase gradient is shown by the dotted line).

FIG. 4B is a chromatogram showing data recorded by a UV spectrometer during an HPLC separation of tryptic peptides from cytochrome C (shown by the solid line) in which the composition of the mobile phase changes in a linear fashion from 2 to 20% acetonitrile between 0-15 minutes and from 20 to 90% acetonitrile between 15-25 minutes (the change in the mobile phase gradient is shown by the dotted line.

FIG. 4C is a chromatogram showing data recorded by a UV spectrometer during an HPLC separation of tryptic peptides from cytochrome C (shown by the solid line) using both a change in mobile phase gradient rate (shown by the dotted line) and by increasing the flow rate beginning 15 minutes into the separation.

All dimensions specified in this disclosure are by way of example only and are not intended to be limiting. Further, the proportions shown in these Figures are not necessarily to scale. As will be understood by those with skill in the art with reference to this disclosure, the actual dimensions of any device or part of a device disclosed in this disclosure will be determined by their intended use.

### DESCRIPTION

Prior chromatography systems generally employ predetermined flow rate and composition profiles to improve performance and increase the speed of separations. In order to enhance such analyses, some liquid chromatography systems make use of “peak parking,” a technique whereby the rate of flow of the mobile phase through the stationary phase is slowed in order to allow more time for a detector to analyze the eluting components (analytes) of a mixture. Current peak parking systems operate in a binary fashion, switching from one flow rate to a pre-set, lower flow rate in order to better analyze an analyte. Because of the lack of flexibility of such systems, these systems may decrease mobile phase flow rates more than necessary to analyze the eluting analyte, thereby increasing the time required to perform the chromatography procedure. On the other hand, the lower flow rate may not be slow enough for an appropriate analysis in some cases. Often peak parking techniques have been implemented so that the remainder of the data from a chromatography run is not maintained.

The present systems and methods allow for faster and more efficient chromatographic analyses by using fluid pressure sources capable of varying fluid pressures in a continuous manner over a predetermined range. By using such pressure sources, the flow rate and/or composition of carrier fluids used to elute the components of a mixture can be varied in a more precise manner so as to increase the efficiency of a chromatography procedure, and/or to improve the quality of the analysis performed by a detector associated with the chromatography system. Such variation in carrier fluid flow rate and/or composition is under the control of a controller, which receives information from a detector and varies fluid flow rate and/or composition as required. These systems are particularly advantageous for separations at very low flow rates (e.g. less than 100 μL/min) using small diameter separation columns (e.g. less than 1 mm diameter). The present system has the further advantage of not shunting excess fluid to waste in order to reduce the mobile phase flow rate, as is done in flow splitting chromatography systems.

Definitions

As used herein, the following terms have the meanings given below, unless a different meaning is clearly intended by the context in which such term is used. Defined terms can be used in the singular or plural without changing their meanings.

“Carrier fluid” refers to any polar or non-polar liquid used to perform column chromatography procedures. The carrier fluid is the mobile phase of a chromatography procedure.

“Chromatography procedure” refers to a liquid chromatography process in which a mixture of substances is separated by charge, size, polarity, chirality, or other property by allowing the mixture to partition between a mobile phase and a stationary phase.

“Chromatography column” refers to a container, generally tubular, for performing chromatography procedures, which has an inlet end and an outlet end and which can retain a stationary phase.

“Column chromatography,” as used herein, refers to liquid chromatography in which carrier fluids are provided under pressure (i.e. a pressure higher than ambient pressure) to a chromatography column.

“Elute” means to extract a material which has been subjected to chromatography from a chromatography column.

“High-Performance Liquid Chromatography” or “HPLC” refers to a column chromatography method in which the liquid mobile phase is contacted with the stationary phase under pressures of from about 7 to 1500 bar (100 to 20,000 pounds per square inch) or higher.

“Liquid chromatography” refers to chromatography in which the mobile phase is a liquid.

“Optimized,” with respect to carrier fluid flow rates or mobile phase gradients used to perform an analysis with the present system, refers to a flow rate or gradient that results in an analytical procedure which is performed in a desired period of time, i.e. within a shorter period of time compared with the period resulting from the conditions of the analytical procedure under conditions which are not optimized. Optimized conditions can in addition or alternatively be those which allow a desired amount of sample data or sample data of a desired quality to be obtained, i.e. more sample data than if the analytical procedure is conducted under conditions which are not optimized.

“Stationary phase” refers to a support material in a chromatography column over or through which the mobile phase flows during a column chromatography procedure. The stationary phase can be, e.g., a solid, a liquid supported on a solid, or a gel, and may include the wall of the chromatography column, e.g., in open tubular chromatography.

As used herein, the term “comprise” and variations of the term, such as “comprising” and “comprises,” are not intended to exclude other additives, components, integers or steps. The terms “a,” “an,” and “the” and similar referents used herein are to be construed to cover both the singular and the plural unless their usage in context indicates otherwise.

Pressure Sources

The pressure sources used in the present systems and methods are continuously variable. Such pressure sources are able to produce fluid pressure changes in small increments over a predetermined range, and hence to produce fine gradations in the flow rates of fluids passing through a chromatography column. Preferably, continuously variable pumps or other liquid pressure sources are able to produce an amount of pressure corresponding to any pressure value over a particular range of values. “Continuously variable,” with respect to flow rates, refers to flow rates corresponding to any value over a particular range of flow rate values. Continuously variable flow rates are achievable with continuously variable pressure sources.

Continuously variable pressure sources are preferably adapted to produce pressures in increments on par with or larger than the amount of random or unintended variation in actual pressure outputs of such pressure sources compared with desired pressure outputs, i.e., on par with or larger than the level of “noise” in a particular continuously variable pressure source. Intended pressure changes smaller than the level of background variation in pressures produced by the pressure source will not be reproducible and/or measurable. The level of noise in a particular pressure source can be determined empirically by measuring the pressures produced by the pressure source in response to a particular set point input. The average of the amounts by which the actual pressures produced by the pressure source exceed or fall short of the intended pressure which is input into and/or intended to be applied by the pressure source can be used as the “noise” level for the pressure source.

Pressure sources can be adapted to produce pressure in predetermined integrals, such as by interacting with a user interface of the present system which allows a user of the system to input pressure values in such predetermined integrals. In one embodiment, such integrals are higher than, and preferably at least twice as high as, the noise level of the pressure source. It is to be understood that a user interface, whether digital or analog, can impose such limits on the pressure values obtainable with a pressure source without changing the continuously variable nature of such pressure sources.

The sources of continuously variable fluid pressure that can be used in the present system can be of any type known in the art, including electrokinetic pumps, such as those disclosed in U.S. Pat. No. 5,942,093 and U.S. Patent Publication No. 2002/0189947; electropneumatic pumps, with and without hydraulic amplifiers, such as those described in U.S. Patent Publication No. 2003/0052007; and mechanically actuated pumps (the foregoing patent and patent application publications are hereby incorporated by reference). Such pumps are continuously variable because they produce pressures of any desired value over the operating range of such pressure sources. Flow splitting-type devices that use multiple split configurations for rapidly reducing the flow rate of a liquid flowing through a chromatography column, by contrast, are not continuously variable because they are limited to discrete flow rates which are determined by the mechanical limitations (i.e., size or capacity of the valves) of such devices. Flow splitting devices reduce flow rates by diverting a selected amount of carrier fluid from a chromatography system with a flow-diverting valve.

The pressure sources used herein preferably provide flow rates in the range of 1 nL/minute to 100 μl/minute into back pressures of up to 20,000 psi (pounds per square inch) or higher. The response time of the pressure source is preferably measured in seconds or less, and more preferably the measured flow rate will substantially equal the desired flow rate within one second, wherein substantially equal means within 5% of the desired flow rate. Examples of a continuously variable pressure source for use in the present systems and methods are the NanoLC and ExpressLC systems produced by Eksigent Technologies, LLC (Dublin, Calif.), which produce continuously variable flow rates in the range of from approximately 1 nL/min to 30 μL/min.

In one embodiment, the continuously variable pressure source is a pneumatic pump, which typically comprises a pneumatic pressure supply coupled to a piston which transfers pressure to a fluid. The continuously variable pressure source can also be of the electrokinetic or electroosmotic type, comprising a dialectric solid (e.g. glass, silica, some plastics and ceramics) in contact with a liquid (e.g. water). When a liquid is placed in contact with a dielectric solid, a thin layer of net charge density is produced in the fluid at the liquid-solid interface. An electrical field can then be applied to produce a Lorentz force on this net charge density and cause an electroosmotic flow of the liquid.

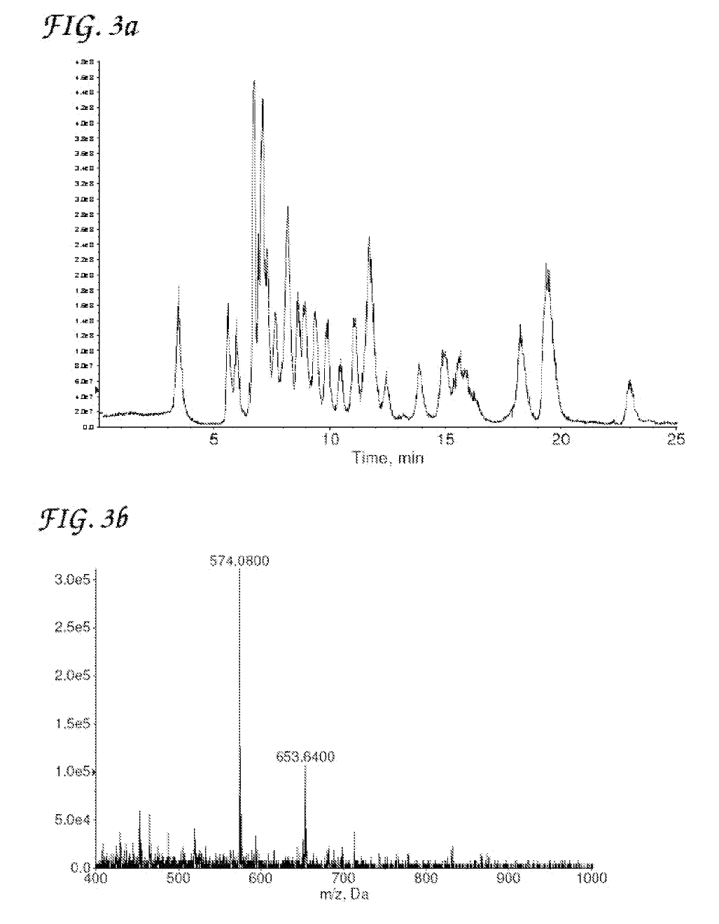

In embodiments in which more than one source of continuously variable fluid pressure is used, the overall flow rate of the mobile phase can be changed by raising or lowering the flow rate of each carrier fluid simultaneously while maintaining the same ratio of fluids, if desired. In such embodiments, the pressure sources can be of the same type or can be of different types. For example, in the embodiment illustrated in FIG. 2, pressure source 10 can be an electropneumatic pump and pressure source 12 can be an electrokinetic pump. Alternatively, the flow rates of each of such pressure sources can be varied independently.

Flowmeters

The flowmeters 30 used in the present system can be of any type known in the art, including but not limited to a Coriolis flowmeter as disclosed in P. Enoksson, G. Stemme and E. Stemme, “A silicon resonant sensor structure for Coriolis mass flow measurements,” J. MEMS vol. 6 pp. 119-125 (1997); an optical flowmeter such as a Sagnac interferometer as disclosed in R. T. de Carvalho and J. Blake, “Slow-flow measurements and fluid dynamics analysis using the Fresnel drag effect, Appl. Opt. vol. 33, pp. 6073-6077 (1994); or a thermal mass-flowmeter”; and a thermal heat tracer as disclosed in U.S. Pat. No. 6,386,050 (the foregoing patent and articles are hereby incorporated by reference). Preferably, the flowmeter 30 provides accurate and precise measurements of flow rates over all desired flow rates, in particular in the range of from 1 nL/min to 100 μL/min. It is also preferable that the flowmeter 30 provide a signal that is continuous. The signal bandwidth of the flowmeter 30, i.e. the frequency corresponding to the minimum time between meaningful readings, is also preferably faster than one Hertz, and more preferably faster than 10 Hertz.

A preferred flowmeter 30 comprises a metering capillary having a sufficiently long length and a sufficiently small inner diameter so that the pressure drop across the metering capillary is at least 5% of the input pressure to the capillary at the desired flow rate or rates. Such flowmeters are used, for example, in the NanoFlow Metering System sold by Eksigent Technologies, LLC. One or more pressure sensors can be used to measure the pressure drop across the capillary directly in such a flowmeter, or the pressure at both ends of the capillary can be measured and one pressure measurement can be subtracted from the other to determine the pressure drop and fluid flow rate.

In one embodiment, the pressure sensor of the flowmeter can be a pressure transducer. Minimizing the volume and size of the pressure transducers to 15 microliters or less allows for rapid response of the flowmeter 30. For example, a pressure drop of about 450 psi through a 10 cm long and 10 micron internal diameter capillary indicates a flow rate of about 500 nL/min for water at room temperature, in accordance with Darcy's law.

A separate flowmeter for each source of continuously variable fluid pressure is generally used in the present system. Flowmeters of different types can be used for each pressure source.

Injectors

Methods and devices known to the art for contacting and/or mixing a sample with one or more carrier fluids and then introducing the sample and carrier fluids into a chromatography column can be used in the present system and methods. Samples are generally contacted with a carrier fluid or fluids via an injector prior to being introduced into a chromatography column. An injector for an HPLC system commonly consists of an injection valve and a sample loop, and the sample is typically dissolved in the carrier fluid before injection into the sample loop. The sample is then drawn into the loop via the injection valve, and a rotation of the valve rotor closes the valve and opens the loop in order to inject the sample into the stream of the carrier fluid. Loop volumes generally range from about 10 nL to over 500 μL. The sample injection is typically automated. The injection valve can be any injection valve known in the art, for example a 4 or 6 port injection valve made by Valco, Scivex or Rheodyne. Additionally, microfabricated injectors, such as those disclosed in U.S. Patent Publication No. 2003/0052007 can be used.

Chromatography Columns and Stationary Phases

Any columns known to the art for use in column chromatography can be used in the present system. In a preferred embodiment, the chromatography columns are capillary columns, i.e. columns having an internal diameter of less than about one millimeter, and more preferably having an internal diameter of from about 10 microns to about 300 microns. Small-bore columns, typically having a diameter of from about 1 to about 2 millimeters, can also be used. For certain chromatography procedures, additional separation columns or other fluidic devices can be used to perform further separations in series following a separation performed on a first column, for example in order to increase analytical sensitivity.

Column chromatography separations which can be performed according to the present methods include, without limitation, adsorption, ion-exchange, size exclusion, chiral interaction, and partition separations. The stationary phase present in the interior of a chromatography column will depend on the type of separation desired to be performed. In adsorption chromatography, silica and alumina are commonly used as the stationary phase, while a stationary phase having ionic side groups, such as chemically modified silica or styrene-divinylbenzene copolymers onto which ionic side groups have been introduced, are generally used in ion-exchange chromatography. In size-exclusion chromatography, the stationary phase materials used can include wide-pore silica gel, polysaccharides, and synthetic polymers like polyacrylamide or styrene-divinylbenzene copolymer. Derivatives of optically active polysaccharides are bonded to silica are typically used in chiral interaction chromatography.

In partition chromatography, the stationary phase is generally either a liquid adsorbed onto a solid or an organic species bonded to a solid. Bonded stationary phases can be prepared, e.g., by reaction of organochlorosilane with the reactive hydroxyl groups on silica. The organic functional group is generally either a straight chain octyl (C-8) or octyldecyl (C-18) group, though it can also be a hexyl, methyl, phenyl, or other organic group. When the stationary phase in partition chromatography is polar (e.g., silica) and the mobile phase is relatively less polar (e.g., n-hexane, ethyl ether, chloroform), this type of separation is referred to as normal-phase chromatography, which is used for the separation of polar compounds. When the mobile phase (e.g., acetonitrile) is polar and the stationary phase (e.g., a C-8 or C-18 bonded phase) is relatively less polar, this type of separation is called reversed-phase chromatography, and is used for separating components that are in the moderately polar to non-polar range.

Mobile Phase

Mobile phases comprise carrier fluids that are specific for the type of separation being performed and/or for the sample being separated. Compounds frequently used as carrier fluids, in order of polarity from least to most polar, include the following: hydrocarbons (least polar), ethers, esters, ketones, aldehydes, amides, amines, alcohols, water (most polar). The following specific carrier fluids, in order of polarity from least to most polar are commonly used: fluoroalkanes (least polar), hexane, isooctane, carbon tetrachloride, toluene, diethyl ether (ether), chloroform, methylene chloride, tetrahydrofuran (THF), acetone, ethyl acetate, dioxane, isopropanol, ethanol, acetic acid, methanol, acetonitrile, water (most polar).

Typical carrier fluids include water, with or without additives to control the ionic strength or pH, acetonitrile, alcohols (including methanol, ethanol, propanol), tetrahydrofuran, hexane, and dichloromethane. Typical carrier fluid additives include acids such as trifluoroacetic acid, formic or acetic acid, phosphate buffers, potassium chloride and sodium chloride. Mobile phases can be composed of a mixture of carrier fluids and can also be changed during the course of a chromatography separation (e.g., gradient chromatography).

Detectors

In the present systems, a detector 60 is in communication with the outlet end 54 of a chromatography column 50 so as to be able to perform analyses of components separated on the column 50 and generate data. The detector 60 typically receive analytes and/or other components which elute from the column 50. Alternatively, in some embodiments, the detector can analyze components at or near the outlet end 54 but before such components elute from the column 50, such as when the detector is an ultraviolet spectrometer.

The detector 60 can be any of those known for detecting analytes separated by column chromatography, including a laser-induced fluorescence detector, an optical absorption detector (such as an ultraviolet spectrometer), a refractive index or electrochemical detector, a mass spectrometer, nuclear magnetic resonance (NMR) spectrometer, electron spin resonance (ESR) spectrometer, or a Raman scattering spectrometer. The information from the detector 60 can include, for example, absorbance at selected wavelength(s), total ion count, ion count at a selected mass-to-charge, total number of unique mass-to-charge ions present, time varying voltage (NMR/ESR), refractive index, fluorescence, Raman scattering, and/or electrical conductivity or current, depending on the detector used.

Multiple detectors can also be used in the present systems, in series or in parallel. For example, an ultraviolet spectrometer can be used in series before a mass spectrometer. In one embodiment, a UV spectrometer can be used to analyze fluid passing through a portion of a polyimide-coated fused silica chromatography column in which a section of the polyimide coating has been removed to create a UV transparent window. Such an absorbance detector can detect the analytes eluting from the column, and generate data which allows the controller to determining that the flow rate of the mobile phase should be changed. Alternatively, the controller can determine the choice of a particular component that will be provided to the next detector in the series. In this way, an analysis can be optimized.

In a preferred embodiment, the detector is a mass spectrometer, and more preferably a tandem mass spectrometer. Tandem (MS-MS) mass spectrometers are instruments that can conduct two or more mass spectroscopy experiments in series, and are used for structural and sequencing studies. Tandem mass spectrometers fragment a sample and analyze the products generated, and can be, for example, of the quadrupole ion trap, quadrupole-quadrupole, quadrupole-time-of-flight, fourier transform ion cyclotron resonance (FT-ICR), or quadrupole ion trap FT-ICR types. In some instruments, the analyzers do not have to be of the same type. Based on data generated by one stage of the mass spectrometer, the controller of the system can change the mobile phase flow rate and/or composition.

A sample under investigation by a mass spectrometer in the present methods is introduced into the ionization source of the instrument and is ionized. The ionization method used by the mass spectrometer will depend on the type of sample under investigation and on the mass spectrometer. Ionization methods include Atmospheric Pressure Chemical Ionization; Chemical Ionization; Electron Impact; Electrospray Ionization (ESI); Fast Atom Bombardment; Field Desorption/Field Ionization; Matrix Assisted Laser Desorption Ionization (MALDI); and Thermospray Ionization. The ionization methods used for the majority of biochemical analyses are Electrospray Ionization (ESI) and Matrix Assisted Laser Desorption Ionization (MALDI). As the flow rate is changed using ESI, the voltage and nebulizer gas flows required for optimized electrospray ionization can be changed, and such change is preferably also under the control of a controller.

Controllers

The pressure sources 10 and 12, flowmeters 30 and 32, and the detector 60 of the present system are preferably in electrical communication with a controller 20 in the present systems. The flow rate as measured by a flowmeter 30 is communicated to the controller 20, which compares this with a desired flow rate that is input into or determined by the controller 20. If the measured flow rate for a carrier fluid or fluids does not equal such a desired flow rate, the controller 20 instructs a pressure modulator of the pressure source 10 and/or of pressure source 12 to adjust the pressure applied by the pressure source 10 in order to achieve the desired flow rate. The desired flow rate can, for example, be less than 100 microliters/minute, less than 10 microliters/minute, or less than 500 nanoliters/minute, such as about 10 nL/min.

In one embodiment, the controller determines the desired flow rate during a chromatography procedure based on information from the detector. For example, the controller can receive data from the detector regarding the presence of one or more analytes eluting from the chromatography column (and received by the detector) and can determine whether the rate at which such analytes are eluting is faster than the rate at which the detector is able to analyze such analytes, or is faster than a rate at which a desired amount of information about the analytes is able to be extracted using the analytical procedure being employed, in which case the controller can decrease the flow rate of a carrier fluid and/or change the carrier fluid composition to slow the elution rate of analytes. Alternatively, the controller can determine that the rate at which such analytes are eluting from a chromatography column is slower than rates at which the detector is able to analyze such analytes, in which case the controller can increase the flow rate of a carrier fluid and/or change the carrier fluid composition in order to speed the rate at which the analytes elute and thereby increase the efficiency of the procedure.

In one embodiment, the controller can determine that the elution rate of analytes from a chromatography column should be increased or decreased by comparing the sample data received from the detector (which can be received either directly from the detector or indirectly via another device, such as a computer, which receives the data from the detector) with data stored in memory in the controller or elsewhere. Such stored data can be preset and acted on automatically by the controller (i.e., without the user needing to send a command to the controller), or can be set by a user of the present system. Such stored data can alternatively be included in circuitry of the controller.

In another example, the controller can be programmed to obtain information regarding the type of detector with which it is placed in electrical communication and to obtain information regarding the maximum rate at which the detector can analyze analytes (where such information can be stored in memory in the controller, in the detector, or in another device in electrical communication with the controller. The maximum rate can be one determined by the manufacturer, or can be set by a user of the present system. The controller can then be programmed to decrease the flow rate of a carrier fluid and/or change the carrier fluid composition to slow the elution rate of analytes during a procedure when the controller receives data from the detector indicating that the maximum rate at which the detector can analyze analytes has been exceeded. Following the receipt of information indicating that a number of components which is greater than a predetermined number is eluting from a chromatography column and entering a detector within a certain period of time, the controller can adjust the pressure applied by the source(s) of continuously variable pressure in order to slow the flow of analytes through the chromatography column and achieve the desired elution rate. Typically, several molecules of the same analyte will elute in a chromatography procedure over the course of a period of time, usually at least several seconds. A quick response by the present system to information provided by the controller can therefore allow analytes which might otherwise not be analyzed, or for which less information would be derived, to be adequately interrogated by a detector.

Likewise, the controller can be programmed to increase analyte elution when such elution is slower than rates at which the detector is able to analyze such analytes. For example, the controller can increase the rate of analyte elution when analytes are detected at a rate which is less than 80%, less than 50%, or less than 20% of the maximum rate at which the detector can analyze analytes.

In another embodiment, the detector can send information to the controller indicating that a particular analyte is eluting from the chromatography column, and the controller can slow the flow rate to allow a more detailed analysis of such analyte to be performed by the detector. Data regarding eluting analytes can alternatively or in addition come from a second detector upstream of another detector.

Preferably, the controller is adapted to determine and then implement optimized flow rates which allow a chromatography procedure to be performed in a minimum amount of time. For example, when analytes are eluting at a rate which is faster than the rate at which the detector is able to analyze such analytes, or at a rate which does not allow the detector to perform analyses at a desired resolution or level of detail, the controller can determine an appropriate flow rate which will allow the analytes to be analyzed by the detector for the amount of time or at the level of detail which has been selected for that chromatography procedure. Preferably, such flow rate is within 20%, more preferably 10%, and even more preferably within 5% of the desired rate for analyzing the analyte. When the need for slowing the chromatography procedure has passed, i.e. when the number of eluting components decreases or a particular analyte has been analyzed, the controller then preferably returns the flow rate to a faster rate.

In other embodiments, the controller can be adapted to increase and decrease the elution of analytes by changing the ratio of two or more carrier fluids being used as the mobile phase. For example, when the detector indicates that there are no analytes eluting from a chromatography column, the controller can cause the pressure sources to alter the carrier fluid mixture in order to increase the elution rate of analytes in the mixture being subjected to chromatography.

The controller 20 can be any type known in the art and can comprise, for example, discrete analog circuits, discrete digital circuits, a dedicated microprocessor (CPU) or a computer. The controller 20 includes an associated memory, such as read-only memory (ROM), containing instructions and parameters for determining an appropriate flow rate for the carrier fluid or fluids, based on information received from the detector 60 and the flowmeter or flowmeters 30, 32. Multiple or nested controllers can also be used. For example, one controller can compare the MS data and flow rate and then communicate with a second controller that changes the flow rate or composition of the chromatography system. Flow rates for the carrier fluid or fluids can also be based on input from a user of the present systems.

Systems

The present systems allow better and more efficient chromatography procedures to be accomplished compared to current systems. In particular, the combination of continuously variable pressure sources and one or more controllers, preferably also in combination with flowmeters, allows carrier fluid pressure and/or composition to be varied dynamically in response to the elution of analyte species of interest. By altering the pressure of the pressure source and hence the carrier fluid flow rate and/or composition, the elution of an analyte can be slowed in order to allow more time for a detector to analyze such species, or can be quickened in order to perform the chromatography procedure more quickly.

As described in U.S. Patent Publication No. 2003/0052007, fast time response pressure sources can be combined with low volume (and therefore capacitance) flow meters and components to provide a system with very fast overall time response. This time response can be used to change the overall flow rate of a system for peak parking type applications, or to change the composition from a multiple pressure source system. For rapid changes in composition to be effective at changing peak elution in a real-time feedback configuration, very low volume mixing and gradient delays must be used. This can be accomplished for smaller diameter separation columns (e.g. less than 500 μm) and lower flow rates (e.g. less than 100 μL/min). Mixers such as those described in U.S. Patent Publication No. 2005/0252840 can be used for such applications.

One figure of merit for characterizing systems involving the use of multiple pressure sources is the ratio between the delay volume, Vd, and the column volume, Vc. The delay volume is the volume of the combined mobile phases from such pressure sources which are present between the point the fluid streams from each pressure source meet and the entry of the mobile phase into the chromatography column. This would include the volume of mobile phase materials in a mixer as well as volumes in injection valves and connector tubing, as applicable. The column volume is the liquid volume of the chromatography column. Since flow rates usually are adjusted based on the column dimensions (diameter and length), Vd/Vc can be used to characterize the ratio between the gradient delay time and time to travel through the column. The smaller the value of Vd/Vc that can be used while maintaining effective and reproducible mixing, the faster a system can respond to changes in the composition of the mobile phase used in a column chromatography procedure, i.e. to gradient changes. This will allow for improved feedback control with less time delay or dampening. In general, smaller values of Vd/Vc will allow for faster chromatography since a smaller delay volume, and therefore delay time, is needed with each run. For the present flow control systems, the value of Vd/Vc can be smaller than 0.5 and preferably smaller than 0.2 or 0.1.

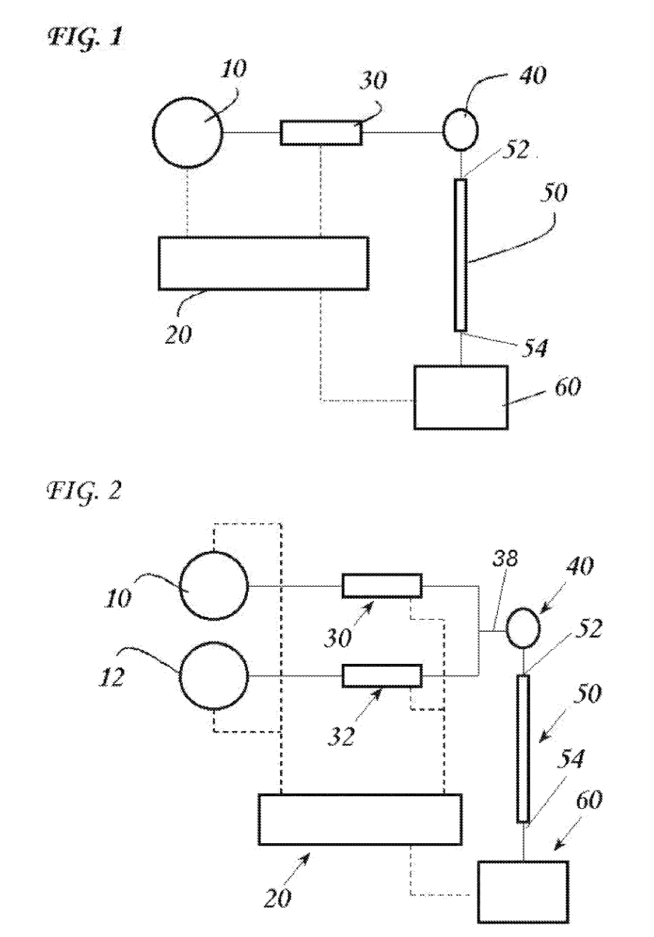

One embodiment of the present system is illustrated in FIG. 1. A source of continuously variable pressure 10 under the control of controller 20 supplies a carrier fluid at a controlled flow rate to a flowmeter 30. The flowmeter 30 measures the flow rate established by the pressure source 10 and provides this information to the controller 20. Carrier fluid next flows to an injector 40, where a sample to be analyzed is contacted with the carrier fluid. The carrier fluid and sample next flow into the inlet end 52 of a liquid chromatography column 50, and separated analytes in the sample elute from the outlet end 54 of the column 50. The outlet end 54 of the column 50 is in communication with a detector 60, and separated analytes preferably flow from the outlet end 54 of the column 50 into the detector 60. The detector 60 provides information to the controller regarding the detection of analytes and components thereof, such as the intensity and duration of signals produced by the detection of such analytes.

FIG. 2 illustrates another embodiment of the present system. This embodiment includes two sources of continuously variable fluid pressure 10 and 12 for two (preferably different) carrier fluids, a flowmeter 30 and 32 for each fluid, and a single fluid outlet 38. A signal from each flowmeter 30, 32 is sent to a controller 20, which in turn adjusts the pressure applied by the pressure sources 10 and 12 so that carrier fluid flows out of the fluid outlet 38 at a desired flow rate. The carrier fluids are mixed after exiting the flowmeters and, preferably, before passing through the fluid outlet 38 into the injector. Mixing can occur via diffusion or via passive or active devices. Preferably, the mixed fluids only need to flow through a minimal volume, 100 nL for example, to the fluid outlet 38, so that changes in mixture composition are accurately represented with little time delay in the fluid exiting through the fluid outlet 38.

Carrier fluids can be directed by the pressure sources 10, 12 to an injector 40 and then into a chromatography column 50. The combination of the sample and carrier fluids in an injector is preferably formed at high pressure and just prior to introduction into the column 50 in order to minimize delay volume. The carrier fluid and sample next flow into the inlet end 52 of the chromatography column 50, and separated analytes in the sample elute from the outlet end 54 of the column 50. Such separated analytes are preferably directed from the outlet end 54 of the column 50 to a detector 60, which provides information to the controller regarding the analytes.

In some embodiments, the detector then processes fluid containing the separated analytes for further analysis. For example, when the detector is a mass spectrometer, the detector can aerosolize such fluid in the process of electrospray ionization prior to mass spectography.

Methods

In one embodiment, the carrier fluid flow rate is changed to provide the desired flow rate based on information derived from the detector 60. For example, an algorithm in the controller 20 can increase the desired flow rate when no compounds (or compounds that do not require increased analysis time) are eluting, and can decrease the desired flow rate when additional analysis time is required. The desired flow rate can be increased, for example, until the detector 60 detects a predetermined number of analytes eluting from a chromatography column within a period time, or until it detects a particular analyte of interest. The flow rate of fluid through the chromatography column can then be decreased until the detector 60 has completed the analysis of the analyte(s), after which the flow rate is increased again. Increasing the flow rate while no analyte is being detected helps to shorten the time needed to perform a chromatography procedure and thus make the procedure more efficient. Decreasing the flow rate while selected analyte(s) are being detected allows higher detection sensitivity and the gathering of more information about the analytes.

Increased analysis time provided by decreased flow rates can improve the signal to noise ratio of data generated by a detector, allowing more reliable identification or quantitation of analytes. For example, when using an absorbance detector, one can monitor signals at a single wavelength to determine when compounds are eluting. However, by decreasing the flow rate while a compound is present in the detection cell (i.e., the portion of a chromatography column or of a detector where an analyte is detected), the amount of time that the analyte is present in the detection cell is increased, and the additional time can be used to scan the absorbance spectrum of the detected analyte. This can provide additional information necessary for identifying the analyte.

Additionally, when multiple analytes are eluting simultaneously, increased analysis time can be used by certain detectors to identify the co-eluting components. For example, a mass spectrometer can be used to detect the ions of multiple, co-eluting compounds. Additional information can then be obtained by serially selecting each ion and subjecting it to fragmentation and measuring the fragmented ions, as in tandem mass spectrometry. Decreasing the flow rate while the compounds are eluting provides additional time for multiple tandem MS experiments.

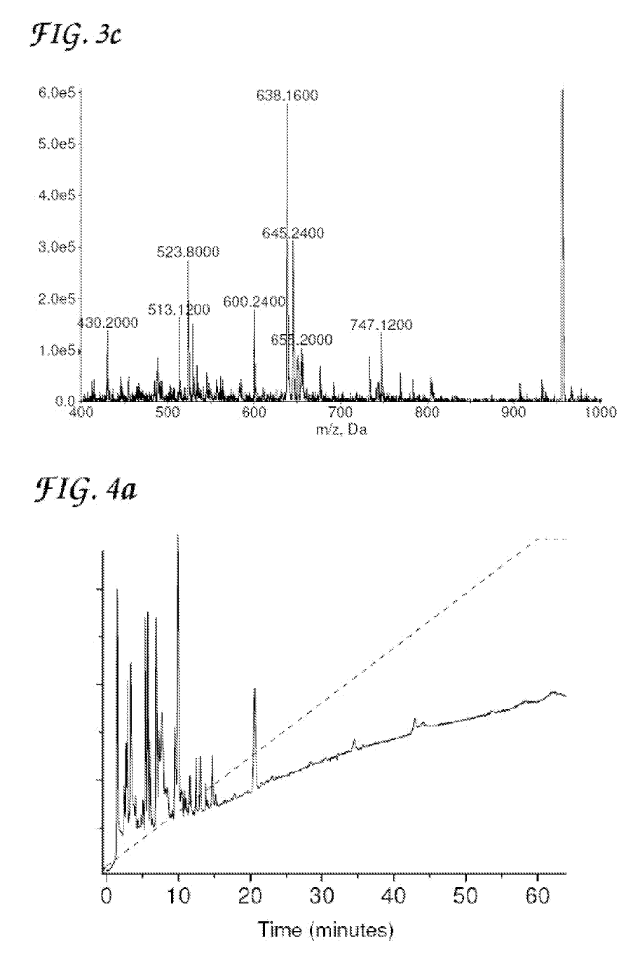

The foregoing is illustrated by the data shown in FIGS. 3A-3C. FIG. 3A shows the total ion chromatogram (TIC) measured by an MS system for a separation of tryptic peptides from bovine serum albumin (BSA) protein. From the TIC, it can be seen that the total signal in the MS varies with elution time. The TIC level is due to the number of ions (m/z values) as well as to the intensities of each of these ions. In FIG. 3B, the average spectrum for ions eluting between 13.17 and 13.27 minutes is displayed. Employing an arbitrary cutoff level of 1e5 counts per second (cps), only two ions (at m/z of 574.0 and 653.8) are present in the spectrum. As an example, these two ions may be easily identified via tandem MS within 0.1 minutes and would therefore not require a drop in flow rate to maximize the number of peptides identified. By contrast, the spectrum in FIG. 3C is taken from elution times between 13.9 and 14.0 minutes. At this time there are approximately 10 or more m/z values that have intensities above 1e5 cps. In order to sequentially perform tandem MS on each of these ions while they are eluting, the present system can decrease the flow rate and provide additional time for the MS detector to identify more of the peptides.

In another embodiment, two or more carrier fluids can be combined in varying ratios in order to provide a carrier fluid mixture of varying composition to a chromatography column. Such varying composition is produced by varying the fluid outputs from one or more pressure sources, thereby creating a carrier fluid gradient, i.e. a ratio between carrier fluids which changes over time. Gradients are typically linear changes in the composition of the mobile phase over time and are usually produced by altering the ratios of at least two different carrier fluids to each other. Carrier fluid gradients however can also include more than two components, and can have other time profiles known to the art, such as parabolic, exponential, stepped or comprising multiple linear regions. A gradient from a mobile phase composition that is mostly water to one that is mostly acetonitrile is typically used.

The pressure applied to each source of carrier fluid and hence the flow rate of such fluid can be varied independently, so that the proportion of each carrier fluid in the mobile phase can be varied. The ratio of the carrier fluids can be altered while maintaining a constant overall flow rate, or the ratio and overall flow rate can be varied simultaneously. Variations in carrier fluid composition can be used to change the elution rate on a longer time scale than flow rate changes due to variations in pressure. The response time for dynamically controlling elution via carrier fluid variation can be, for example, on the order 0.2-3 minutes or longer. The time response is determined by the extracolumn volume, the column void volume, the flow rate, and on the chemical properties of the fluid mixture. The ability to change the elution rate on the several minute time scale can be beneficial for longer separations, for example, those on the order of 0.5-3 hours.

In one embodiment, the gradient slope (and hence the rate of sample component elution) can be increased when the controller 20 detects that the analytical ability of the detector 60 is underutilized, such as when relatively few analytes are eluting. For example, in reverse phase chromatography, the hydrophobic character of the mobile phase can be increased during the experiment, resulting in a decreased retention time of analytes on the stationary phase and an increased rate of elution. This embodiment is especially advantageous when coupled with the use of higher pressures and flow rates to increase analyte elution rates, as such elution rates can be increased to a greater degree than through the use of pressure alone. The gradient slope can also be decreased during a chromatography procedure, for example when the controller 20 detects that the number of eluting species is higher.

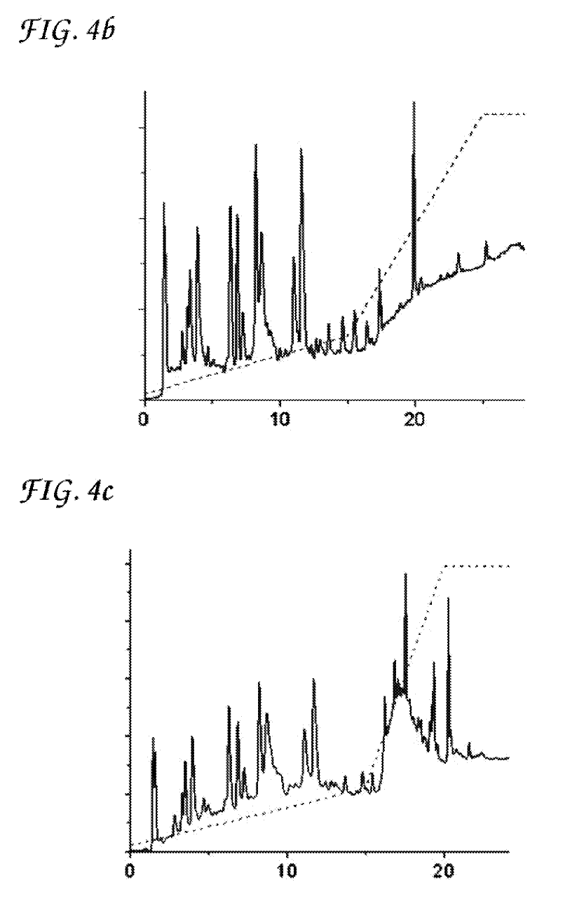

For example, data showing the elution of peptides from a protein digest of cytochrome C are shown in FIGS. 4A-4C. In FIG. 4A, a linear gradient change in mobile phase composition from 2% to 90% acetonitrile is shown. It can be observed that many of the peptides elute during the first 16 minutes in this experiment, with a few additional peaks observed out to 45 minutes or longer. However, by simply modifying the gradient profile, i.e., the rate of change of the composition of the mobile phase, to include one region (2-20% acetonitrile between 0-15 minutes) with a shallower slope and one region (20-90% acetonitrile between 15-25 minutes) with a steeper slope as shown in FIG. 4B, one can elute most of the compounds in this sample in a shorter overall time while still maintaining or improving the separation during the initial part of the chromatogram. Using the present systems, an adaptive gradient that is generated from the feedback of a detector signal to the system controller can be used to generate an improved gradient and separation in real-time in a single run, rather than needing to conduct multiple runs in order to produce an acceptable analysis.

This embodiment is particularly useful in controlling the deposition of the column eluent onto a solid substrate, such as a MALDI target. For example, a nondestructive detector 60 such as an ultraviolet absorbance detector 60 can be used to monitor the rate at which compounds elute from the column at a constant flow rate. At low rates of analyte elution the gradient could be performed rapidly. As the density of eluting analytes increases, as detected by the ultraviolet detector, the gradient slope can be adjusted to improve the resolution between closely eluting compounds. This can be done at a constant flow rate, ensuring a uniform spot size on the solid target with a relatively constant number of analytes in each spot.

In yet another embodiment, both overall flow rate and mixture composition (gradient profile) of the carrier fluids can be varied simultaneously. As an illustration, FIG. 4C shows another separation of the tryptic peptides from cytochrome C protein. In this case multiple different gradient rates are employed (as described previously and illustrated in FIG. 4B). In addition, the total flow rate is also increased at 15 minutes, allowing even faster elution of peptides during the second section of the gradient.

### EXAMPLE 1

### Optimizing Flow Rates for Detecting Multiple Molecular Species

Peptides from a cytochrome c tryptic digest are separated on an HPLC column using a gradient in mobile phase from 90% fluid A to 20% fluid A in 30 minutes, where fluid A is 0.1% trifluoroacetic acid (“TFA”) in water and fluid B is water with 0.1% TFA and 80% acetonitrile. A 15 cm long capillary column having an internal diameter of 100 μm, packed with 3 μm C₁₈ particles, is used. An initial flow rate of 400 nL/min is established by an electropneumatic pump, such as that provided with the NanoLC-1D System (sold by Eksigent Technologies, Dublin, Calif., U.S.A.). The eluate from the column is directed to a quadrupole-time-of-flight tandem mass spectrometer system (“QTOF”) using electrospray ionization.

The QTOF is in electrical communication with a controller. When a molecular species is detected by the QTOF, a signal is sent to the controller indicating the intensity (counts) versus time for that molecular species. Peaks in this assay are observed to have a duration of approximately 5 seconds per molecular species under the flow rate and carrier fluid conditions of this separation. MS-MS experiments are conducted to interrogate one molecular species per second.

The QTOF detects 8 molecular species eluting from the HPLC column in a peak. The controller sends a signal to the electropneumatic pump which then reduces the flow rate of the column within 1 second to 200 nL/min, thereby lengthening the duration of the peak to approximately 10 seconds. This allows the mass spectrometer to interrogate each molecular species in this peak. The QTOF conducts MS-MS on each of the 8 molecular species in about 10 seconds. It communicates this to the controller, and the controller then sends a signal to the electropneumatic pump to increase the column flow rate to 400 nL/min.

At a later time, the QTOF detects 15 molecular species eluting from the HPLC column in a peak. The controller sends a signal to the electropneumatic pump which then reduces the flow rate of the column within 1 second to 100 nL/min, thereby lengthening the duration of the peak to approximately 20 seconds. This allows the mass spectrometer to interrogate each molecular species in this peak. The QTOF conducts MS-MS on each of the 15 molecular species in about 20 seconds. It communicates this to the controller, and the controller then sends a signal to the electropneumatic pump to increase the column flow rate to 400 nL/min.

### EXAMPLE 2

### Optimizing Flow Rates for Detecting Molecular Species at High Concentration

Peptides from a cytochrome c tryptic digest are separated on an HPLC column using a gradient in mobile phase from 90% fluid A to 20% fluid A in 30 minutes, where fluid A is 0.1% TFA in water and fluid B is water with 0.1% TFA and 80% acetonitrile. A 15 cm long capillary column having an internal diameter of 100 μm, packed with 3 μm C₁₈ particles, is used. An initial flow rate of 400 nL/min is established by an electropneumatic pump, such as that provided with the NanoLC-1D System (sold by Eksigent Technologies, Dublin, Calif., U.S.A.). The eluate from the column is directed to a quadrupole mass spectrometer (“QMS”) system using electrospray ionization.

The QMS is in electrical communication with a controller. When a molecular species is detected by the QMS, a signal is sent to the controller indicating the intensity (counts per second) versus time for that molecular species. Peaks in this assay are observed to have a duration of approximately 5 seconds per molecular species under the flow rate and carrier fluid conditions of this separation.

The QMS detects a molecular species eluting from the HPLC column in an intense peak (a peak on the order of 100 times larger than the typical background signal). The controller sends a signal to the electropneumatic pump which then increases the flow rate of the column within 1 second to 1000 nL/min, thereby shortening the duration of the peak to approximately 2 seconds, but still allowing enough time for accurate identification and analysis. The flow rate is then maintained at 1000 nL/min until additional molecular species are detected at lower intensities. The controller then sends a signal to the electropneumatic pump to reduce the column flow rate to 400 nL/min.

### EXAMPLE 3

### Optimizing Flow Rates for Detecting Molecular Species at Low Concentration

Peptides from a cytochrome c tryptic digest are separated on an HPLC column using a gradient in mobile phase from 90% fluid A to 20% fluid A in 30 minutes, where fluid A is 0.1% trifluoroacetic acid (“TFA”) in water and fluid B is water with 0.1% TFA and 80% acetonitrile. A 15 cm long capillary column having an internal diameter of 100 μm, packed with 3 μm C₁₈ particles, is used. An initial flow rate of 400 nL/min is established by an electropneumatic pump, such as that provided with the NanoLC-1D System (sold by Eksigent Technologies, Dublin, Calif., U.S.A.). The eluate from the column is directed to a quadrupole time-of-flight mass spectrometer system (“QTOF”) using electrospray ionization.

The QTOF is in electrical communication with a controller. When a molecular species is detected by the QTOF, a signal is sent to the controller indicating the intensity (counts per second) versus time for that molecular species. Peaks in this assay are observed to have a duration of approximately 5 seconds per molecular species under the flow rate and carrier fluid conditions of this separation.

The QTOF detects a molecular species eluting from the HPLC column with very few counts per scan (a weak intensity peak). The controller sends a signal to the electropneumatic pump which then decreases the flow rate of the column within 1 second to 100 nL/min, thereby increasing the duration of the peak to approximately 20 seconds. The allows the QTOF to collect MS-MS spectra for four times longer, increasing the signal to noise for the measurement and increasing the reliability of the identification of the molecular species. After the QTOF has collected a sufficient number of spectra, the controller sends a signal to the electropneumatic pump to increase the column flow rate to 400 nL/min.

### EXAMPLE 4

### Optimizing Composition for Detecting Multiple Species

Peptides from a cytochrome c tryptic digest are separated on an HPLC column using a gradient in mobile phase starting from 98% fluid A to 98% fluid B, where fluid A is 0.1% formic acid (“FA”) in water and fluid B is acetonitrile with 0.1% FA. A 15 cm long capillary column having an internal diameter of 75 μm, packed with 5 μm C₁₈ particles, is used. An initial flow rate of 500 nL/min is established by an electropneumatic pump, such as that provided with the NanoLC-1D System (sold by Eksigent Technologies, Dublin, Calif., U.S.A.). The eluate from the column is directed to a quadrupole time-of-flight mass spectrometer system (“QTOF”) using electrospray ionization.

The QTOF is in electrical communication with a controller. When a molecular species is detected by the QTOF, a signal is sent to the controller indicating the intensity (counts per second) versus time for that molecular species.

The chromatographic elution is initiated with a composition gradient rate of 1% B per minute. The QTOF detects very few molecular species eluting from the chromatography column for the first 20 seconds of the analysis. The controller sends a signal to the electropneumatic pumps to increase the gradient rate in the mobile phase composition to 2% B/minute. The QTOF then begins to detect peptides and conduct tandem MS to sequence and identify the peptides. As the number of peptides eluting from the column becomes too great to allow good tandem MS spectra of each peptide, the controller sends a signal to the electropneumatic pumps to reduce the gradient rate back to 1% B/minute. The number of peptide species eluting from the column continues to increase and the controller signals the pumps to reduce the gradient rate further. Once the rate of peptide elution is once again small enough to allow time for tandem MS and identification, the controller signals the pumps to begin to increase the gradient rate once again.

Although the present invention has been discussed in considerable detail with reference to certain preferred embodiments, other embodiments are possible. The steps disclosed for the present methods are not intended to be limiting nor are they intended to indicate that each step depicted is essential to the method, but instead are exemplary steps only. Therefore, the scope of the appended claims should not be limited to the description of preferred embodiments contained in this disclosure. All references cited herein are incorporated by reference to their entirety.

What is claimed is:

1. A chromatography system for analyzing a sample, comprising:
(a) a first source of continuously variable fluid pressure for applying pressure to a first carrier fluid;
(b) a first chromatography column having an inlet end and an outlet end, wherein the inlet end of the chromatography column is in fluid communication with the first source of continuously variable fluid pressure;
(c) a first detector in fluid communication with the outlet end of the first chromatography column; and
(d) one or more controllers in electrical communication with the first source of continuously variable fluid pressure and with the first detector, wherein the one or more controllers comprise circuitry for:
(i) receiving sample data from the first detector;
(ii) determining a desired flow rate for the first carrier fluid based on the sample data; and
(iii) adjusting the pressure applied by the first source of continuously variable fluid pressure to achieve the desired flow rate for the first carrier fluid.

2. The system of claim 1, further comprising a second source of continuously variable fluid pressure for applying pressure to a second carrier fluid, the second source of continuously variable fluid pressure being in electrical communication with the one or more controllers and in fluid communication with the inlet end of the first chromatography column.

3. The system of claim 2, wherein the one or more controllers further comprise circuitry for determining a desired flow rate for the second carrier fluid based on the sample data.

4. The system of claim 3, wherein the desired flow rate for the first carrier fluid and the second carrier fluid changes over time, thereby providing a carrier fluid gradient.

5. The system of claim 2, wherein the system has a ratio between its delay volume and its column volume of less than 0.5.

6. The system of claim 1, further comprising a flowmeter in fluid communication with the first source of continuously variable fluid pressure and with the first chromatography column, wherein the flowmeter is in electrical communication with the one or more controllers and wherein the one or more controllers comprise circuitry for receiving flow rate data from the flowmeter.

7. The system of claim 1, wherein the first chromatography column has an internal diameter of 2 millimeters or less.

8. The system of claim 1, wherein the first source of continuously variable fluid pressure is a device selected from the group consisting of a pneumatic pump, an electrokinetic pump, and an electrokinetic flow controller.

9. A chromatography system for analyzing a sample, comprising:
(a) a first source of continuously variable fluid pressure for applying pressure to a first carrier fluid;
(b) a first flowmeter in fluid communication with the first source of continuously variable fluid pressure; and
(c) one or more controllers in electrical communication with the first source of continuously variable fluid pressure and with the first flowmeter, wherein the one or more controllers comprise circuitry for:
(i) receiving sample data from a first detector;
(ii) utilizing the sample data to determine an optimized flow rate for the first carrier fluid for analyzing the sample in a desired period of time or in a manner which allows a desired amount or quality of sample data to be obtained;
(iii) receiving flow rate data from the first flowmeter;
(iv) comparing the flow rate data to the optimized carrier fluid flow rate; and
(v) adjusting the pressure applied by the first source of continuously variable fluid pressure to achieve the optimized flow rate for the first carrier fluid.

10. The system of claim 9, further comprising:
a second source of continuously variable fluid pressure for applying pressure to a second carrier fluid, the second source of continuously variable fluid pressure being in electrical communication with the one or more controllers; and
a second flowmeter in fluid communication with the second source of continuously variable fluid pressure and in electrical communication with the one or more controllers,
wherein the one or more controllers further comprise circuitry for determining an optimized flow rate for the second carrier fluid based on the sample data and for adjusting the pressure applied by the second source of continuously variable fluid pressure to achieve the optimized flow rate for the second carrier fluid.

11. The system of claim 10, wherein the optimized flow rate for the first carrier fluid and the second carrier fluid changes over time, thereby providing an optimized carrier fluid gradient.

12. The system of claim 10, wherein the system has a ratio between its delay volume and its column volume of less than 0.5.

13. The system of claim 9, wherein the sample data comprises the number of analytes entering the detector during a predetermined period of time.

14. The system of claim 13, wherein the optimized flow rate of the first carrier fluid results in the detector receiving analytes at a rate which is less than a predetermined maximum rate for the detector.

15. A method for performing a chromatography procedure, comprising the steps of:
(a) applying pressure from a first source of continuously variable fluid pressure to a first carrier fluid in order to flow the first carrier fluid at a first flow rate of less than about 100 μL/min;
(b) contacting the sample with the first carrier fluid;
(c) flowing the sample and the carrier fluid through a chromatography column;
(d) analyzing components of the sample with a detector, thereby generating sample data;
(e) processing the sample data with one or more controllers to determine whether the rate at which analytes are being detected by the detector is greater than a predetermined maximum rate or is less than a predetermined rate at which the detector can analyze analytes;
(f) determining a second flow rate for the first carrier fluid with the one or more controllers when the rate at which analytes are being detected by the detector is greater than the predetermined maximum rate or is less than the predetermined rate at which the detector can analyze analytes, wherein the second flow rate results in a flow of analytes into the detector which is less than the predetermined maximum rate or is greater than the predetermined rate at which the detector can analyze analytes; and
(g) changing the pressure applied by the first source of continuously variable fluid pressure and thereby changing the flow rate of the first carrier fluid from the first flow rate to the second flow rate.

16. The method of claim 15, further comprising the steps of:
applying pressure from a second source of continuously variable fluid pressure to a second carrier fluid in order to flow the second carrier fluid at a first flow rate of less than about 100 μL/min;
mixing the first carrier fluid and the second carrier fluid prior to contacting the sample with the first carrier fluid;
determining a second flow rate for the second carrier fluid with the one or more controllers when the rate at which analytes are being detected by the detector is greater than the predetermined maximum rate or is less than the predetermined rate at which the detector can analyze analytes, wherein the second flow rate for the second carrier fluid results in a flow of analytes into the detector which is less than the predetermined maximum rate or is greater than the predetermined rate at which the detector can analyze analytes; and
changing the pressure applied by the second source of continuously variable fluid pressure and thereby changing the flow rate of the carrier fluid from the first flow rate to the second flow rate for the second carrier fluid.

17. The method of claim 16, wherein pressure is applied by the first source of continuously variable fluid pressure and the second source of continuously variable fluid pressure to produce a first carrier fluid gradient, and wherein adjusting the pressure applied by one or both of the first source of continuously variable fluid pressure and the second source of continuously variable fluid pressure produces a second carrier fluid gradient.

18. The method of claim 17, wherein the second carrier fluid gradient comprises a time profile selected from the group consisting of linear, parabolic, exponential, and stepped.

19. The method of claim 16, wherein the system has a ratio between its delay volume and its column volume of less than 0.5.
